(19) United States
(12) Patent Application Publication
(10) Pub. No.: US 2012/0295003 A1
(43) Pub. Date: Nov. 22, 2012

(54) Foof flavouring composition

(76) Inventor: Leon Daniel, Thornhill (CA)

(21) Appl. No.: 13/506,716

(22) Filed: May 11, 2012

Related U.S. Application Data
(60) Provisional application No. 61/457,693, filed on May 16, 2011.

(51) Int. Cl. A23L 1/22

(52) U.S. Cl. 426/548

(57) ABSTRACT

A food flavouring product for adding a sweet flavour to foods and which contains a mixture of erythritol, inulin of chickory root, gum arabic, an extract of stevia, and a compound selected from the group comprising ascorbic acid, and lactic acid, and citric acid, in a certain range of predetermined proportions. Preferably the stevia extract is in the form of rebaudioside-A, (stevia glycosides).

This application is based on U.S. Provisional application Ser. No. 61/457,693, Filed May 16, 2011, entitled Food Flavouring Composition, inventor Leon Daniel, the priority of which application is claimed.

### FIELD OF THE INVENTION

The invention relates to an edible sweet-flavouring product for adding to various foods, and in particular to an edible, non toxic, non-allergenic, digestible, sweetener flavouring.

### BACKGROUND OF THE INVENTION

Adding sweet flavour to foods has been carried out with harmless, non-toxic, digestible natural products since biblical times. Honey was the main source.

Some herbal products also have a sweet flavour.

Since the development of the sugar cane industry, plant sugar originating in the cane has been available. However, the extreme degree of processing to which cane sugar is subjected, renders the refined product to some extent harmful.

Also, it can pass through the stomach and small intestine rapidly, with little digestion.

Such undigested cane sugar is believed to pass into the colon where it assists in proliferation of undesirable bacteria.

The principal valuable minerals present in the original cane sugar are removed in refining, and is known as molasses for which there are fewer markets, except as colouring for certain foods and beverages.

Refined cane sugar seems to accumulate in body tissue. It seems to have a possible effect on the production of insulin. It may cause extreme fluctuations in blood sugar.

Cane sugar, partly due to its almost universal use in many edible products, may be one factor in the cause of tooth decay. Refined sugar varies in price, as do all commodities, and can have a significant effect on the price of the end product.

For example soda drinks are said to contain two pounds of refined sugar in every case of twenty-four cans. Beverages such as beer also contain large amounts of sugar.

Pharmaceutical and health products often contain large proportions of sugar, to render them more palatable to the consumer.

Variations in the price of sugar can thus have a major effect on the cost of such products.

For all these reasons synthetic sugar substitutes of various kinds have been developed, and some are in very wide use. Such products when used as food additives, are frequently promoted as being “low in calories” when in fact they may cause the body to accumulate more weight, than if the same food products were sweetened with natural cane sugar. There is a growing concern amongst both health professionals, and consumers that such substitutes are not entirely free from undesirable side effects. Accordingly it is desirable to create a sweetener product, which avoids the use of actual cane sugars, but which is free from undesirable or damaging side effects, and is non-toxic, and harmless.

### BRIEF SUMMARY OF THE INVENTION

Accordingly the invention provides a dry powder food flavouring product for adding a sweet flavour to foods and which contains a mixture of erythritol, inulin of chicory root, gum arabic, an extract of stevia, and a compound selected from ascorbic acid, or lactic acid, or citric acid, in a range of predetermined proportions comprising
Erythritol from 35.0% to 70.0%
Inulin from Chicory Root from 10.0% to 25.0%
Gum Arabic from 10.0% to 25.0%
Stevia Rebaudiana Leaf Extract from 2.5% to 8.5%
Compound selected from ascorbic and Citric and Lactic Acid from 0.3% to 1.5%

Preferably the stevia extract will be as rebaudioside-A, (stevia glycosides).

The various features of novelty which characterize the invention are pointed out with more particularity in the claims annexed to and forming a part of this disclosure. For a better understanding of the invention, its operating advantages and specific objects attained by its use, reference should be made to the descriptive matter in which there are described preferred embodiments of the invention.

### DESCRIPTION OF A SPECIFIC EMBODIMENT

As explained above the invention provides a non-toxic harmless flavouring product for adding a sweet flavour to foods, with outside effects,

The sweet-flavouring product contains the following components:

### Ingredients:

erythritol, soluble food fibers (inulin of chicory root and acacia gum), stevia leaf extract rebaudioside A (or steviol glycosides with rebaudioside A [SG-RS]) ≧97% and at least one compound selected from ascorbic acid, lactic acid, or citric acid.
Erythritol from 35.0% to 70.0%
Inulin from Chicory Root from 10.0% to 25.0%
Gum Arabic from 10.0% to 25.0%
Stevia Rebaudiana Leaf Extract Rebaudioside A≧0.95% from 2.5% to 8.5%
Compound selected from Ascorbic and Citric and Lactic Acid from 0.3% to 1.5%

Preferably the stevia extract will be as rebaudioside-A, (stevia glycosides).

Erythritol ((2R,3S)-butane-1,2,3,4-tetraol) is a sugar alcohol (or polyol) that has been approved for use as a food additive in the United States^{[1]} and throughout much of the world. It occurs naturally in some fruits and fermented foods.^{[3]} At the industrial level, it is produced from glucose by fermentation with a yeast, Moniliella pollinis.^{[1]} It is 60-70% as sweet as table sugar yet it is almost non-caloric, does not affect blood sugar, does not cause tooth decay, and is partially absorbed by the body, and is excreted in urine and feces. It is less likely to cause gastric side-effects than other sugar alcohols due to its unique digestion pathway

Gum arabic, also known as acacia gum, chaar gund, char goond, or meska, is a natural gum made of hardened sap taken from two species of the acacia tree; Acacia senegal and Acacia seyal. The gum is harvested commercially from wild trees throughout the Sahel from Senegal and Sudan to Somalia, although it has been historically cultivated in Arabia and West Asia. Gum arabic, a complex mixture of polysaccharides and glycoproteins, is used primarily in the food industry as a stabilizer. It is edible and has E number E414. Gum arabic is a key ingredient in traditional lithography and is used in printing, paint production, glue, cosmetics and various industrial applications, including viscosity control in inks and in textile industries, although less expensive materials compete with it for many of these roles. Middle Eastern populations use the natural gum to make a chilled, sweetened, and flavored gelato-like dessert.

Acacia gum's mixture of saccharides and glycoproteins gives it the properties of a glue and binder which is edible by humans. Other substances have replaced it in situations where toxicity is not an issue, as the proportions of the various chemicals in gum arabic vary widely and make it unpredictable. Still, it remains an important ingredient in soft drink syrups, “hard” gummy candies such as gumdrops, marshmallows, M&M's chocolate candies and edible glitter, a very popular, modern cake-decorating staple

Inulins are a group of naturally occurring polysaccharides produced by many types of plants.^{[1]} They belong to a class of fibers known as fructans. Inulin is used by some plants as a means of storing energy and is typically found in roots or rhizomes. Most plants that synthesize and store inulin do not store other materials such as starch. Inulin is increasingly used in processed foods because it has unusually adaptable characteristics. Its flavour ranges from bland to subtly sweet (approx. 10% sweetness of sugar/sucrose).^{[2]} It can be used to replace sugar, fat, and flour. This is advantageous because inulin contains 25-35% of the food energy of carbohydrates (starch, sugar).^{[3]} In addition to being a versatile ingredient, inulin has many health benefits. Inulin increases calcium absorption^{[4]} and possibly magnesium absorption,^{[5]} while promoting the growth of intestinal bacteria. In terms of nutrition, it is considered a form of soluble fiber and is sometimes categorized as a prebiotic. Due to the body's limited ability to process fructans, inulin has minimal increasing impact on blood sugar, and—unlike fructose—is not insulemic and does not raise triglycerides,^{[6]} making it considered suitable for diabetics and potentially helpful in managing blood sugar-related illnesses.

### Stevia

Stevia rebaudiana, commonly known as sweetleaf, sweet leaf, sugarleaf, or simply stevia, is widely grown for its sweet leaves. As a sweetener and sugar substitute, stevia's taste has a slower onset and longer duration than that of sugar, although some of its extracts may have a bitter or licorice-like aftertaste at high concentrations.

steviol glycoside extracts have up to 300 times the sweetness of sugar.

Stevia has a negligible effect on blood glucose, and is attractive as a natural sweetener to people on carbohydrate-controlled diets.

Ascorbic acid, citric acid and lactic acid are well known edible compounds, found many natural foods.

### Product Applications:

Recommended as a natural multipurpose food additive for use in preparation of the traditional, functional and organic foods and natural health products—to sweeten the final products and improve the texture, consistency and freshness, and also to extend the shelf life of the product.

### Suggested Percentage:

10% or less of the total weight of the finished product.

### Product Uses/Purposes:

as a natural sweetener to substitute for cane sugar and for synthetic sugar substitutes;
as a texture and consistency improver and a freshness stabilizer of the finished product;
as an extender of shelf life by decreasing a water activity of the finished product.

### Product Benefits:

highly effective as a replacement for cane sugar and for synthetic sugar substitutes;
provides natural sweetness;
enhances and improves the taste and flavor of the finished product;
no undesirable aftertaste and bitterness;
no chemical agents;
improves texture and retains the freshness of the finished product for a long time;
highly resistant to aggressive media: high temperature, acidity, alcohols;
not subject to fermentation by microorganisms;
does not undergo to caramelization during baking or frying processes, resulting in improved appearance of the finished product which is lighter than the same product in which cane sugar is used;
excellent flow ability of the mixture;
may be added at any processing stage;
is cold water soluble;
extends the shelf life of the finished product;
helps to minimize intake of cane sugar and avoids intake of artificial ingredients thereby contributing to a healthy balance diet;
safer for diabetics and can be used to sweeten foods to provide a sugar-free diet;
brings a rich source of soluble food fibers important for a digestive health;
can be used as part of a calorie reduced diet to achieve weight loss;
reduces tooth decay due to cane sugars.

Experiments to determine an acceptable range of proportions have been conducted as follows;

### Experiment 1:

We measured the following components by weight as follows:

| | | |
|---|---|---|
| Erythritol | g | 750 |
| Rebaudioside A, 97% (powder) | g | 85 |
| Inulin of Chicory Root | g | 80 |
| Gum Arabic | g | 70 |
| Citric Acid and/or Lactic Acid, or Ascorbic Acid | g | 15 |

| | |
|---|---|
| Total: | 1000 |

These components were blended in an electrical blender without the mixing devices inside (i.e. paddles, blades), with keeping the following steps and conditions:

1) the components were started to put into the blender in accordance with the principle—first add the smallest amount;
2) all added components were mixed about 3-5 minutes by use a slow speed of the blender.

The dry blended compound was then tested by mixing 1 g in a 250 ml of tea. The test could show the following:

a) the taste was very excessively sweet and felt an undesirable bitter aftertaste and unfavorable lingering;
b) at the same time, could felt sour taste;
c) some samples of tea were less sweeter than other samples of the same tea, that means that the blending time by use a slow speed of the blender, should be more than 5 minutes.

The proportions of components were then changed.

### Experiment 2:

Same procedures and steps as for Experiment 1, except a mixing time—6-8 minutes.

| | | |
|---|---|---|
| Erythritol | g | 732 |
| Inulin of Chicory Root | g | 90 |
| Acacia Gum | g | 85 |
| Rebaudioside A, 97% (powder) | g | 80 |
| Citric Acid and/or Lactic Acid, or Ascorbic Acid | g | 13 |

| | |
|---|---|
| Total: | 1000 |

The test could show the following:

a) the taste was excessively sweet and felt an undesirable bitter aftertaste and unfavorable lingering;
b) at the same time, could felt sour taste but less than in Experiment 1;
c) some samples of tea were less sweeter than other samples of the same tea but better than in Experiment 1; that means that this blending time is better;
d) an increasing of the amount of Inulin and Gum Arabic were positively influenced on the taste.

The proportions of components were then changed.

### Experiment 3:

Same procedures and steps as for Experiment 1, except changing the amount of components.

| | | |
|---|---|---|
| Erythritol | g | 730 |
| Inulin of Chicory Root | g | 95 |
| Gum Arabic | g | 90 |
| Rebaudioside A, 97% (powder) | g | 75 |
| Citric Acid and/or Lactic Acid, or Ascorbic Acid | g | |

| | |
|---|---|
| Total: | 1000 |

The test could show the following:

a) the taste was more than sufficiently sweet and felt an undesirable bitter aftertaste and unfavorable lingering, but less than in Experiment 2;
b) at the same time, could felt sour taste but much less than in Experiment 2;
c) all samples of tea have been sweeten equally than in Experiment 2; that means that the blending time 8-10 minutes by use a slow speed of the blender is enough to get an equality of the blending of components;
d) the taste of dry blended compound was better in the case of use Citric Acid and/or Lactic Acid.

The proportions of components were then changed.

### Experiment 4:

Same procedures and steps as for Experiment 1, except changing the amount of components.

| | | |
|---|---|---|
| Erythritol | g | 700 |
| Inulin of Chicory Root | g | 115 |
| Gum Arabic | g | 106 |
| Rebaudioside A, 97% (powder) | g | 70 |
| Citric Acid and/or Lactic Acid, or Ascorbic Acid | g | 9 |

| | |
|---|---|
| Total: | 1000 |

The test could show the following:

a) the taste was more than sufficiently sweet and felt an undesirable bitter aftertaste and unfavorable lingering but less than in Experiment 3;
b) at the same time, the sour taste could felt a little bit;
c) all samples of tea have been sweeten equally;
d) the taste of dry blended compound was better in the case of use Citric Acid and/or Lactic Acid.

The proportions of components were then changed.

### Experiment 5:

Same procedures and steps as for Experiment 1, except changing the amount of components.

| | | |
|---|---|---|
| Erythritol | g | 650 |
| Inulin of Chicory Root | g | 143 |
| Gum Arabic | g | 134 |
| Rebaudioside A, 97% (powder) | g | 65 |
| Citric Acid and/or Lactic Acid, or Ascorbic Acid | g | 8 |

| | |
|---|---|
| Total: | 1000 |

The test could show the following:

a) the taste was more than sufficiently sweet but less than in Example 4, and felt an undesirable bitter aftertaste and unfavorable lingering but much less than in Experiment 4;
b) at the same time, the sour taste was not felt;
c) all samples of tea have been sweeten equally;
d) the taste of dry blended compound was better in the case of use Citric Acid and/or Lactic Acid.

The proportions of components were then changed.

### Experiment 6:

Same procedures and steps as for Experiment 1, except changing the amount of components.

| | | |
|---|---|---|
| Erythritol | g | 450 |
| Inulin of Chicory Root | g | 258 |
| Gum Arabic | g | 249 |
| Rebaudioside A, 97% (powder) | g | 35 |
| Citric Acid and/or Lactic Acid, or Ascorbic Acid | g | 8 |

| | |
|---|---|
| Total: | 1000 |

The test could show the following:

a) the taste was not sufficiently sweet and felt without a bitterness but with an unfavorable aftertaste than in Experiment 5;
b) at the same time, the sour taste was not felt;
c) all samples of tea have been sweeten equally;
d) the taste of dry blended compound was better in the case of use Citric Acid and/or Lactic Acid.

The proportions of components were then changed.

### Experiment 7:

Same procedures and steps as for Experiment 1, except changing the amount of components.

| | | |
|---|---|---|
| Erythritol | g | 500 |
| Inulin of Chicory Root | g | 228 |
| Gum Arabic | g | 219 |
| Rebaudioside A, 97% (powder) of PURE CIRCLE USA, INC. | g | 45 |
| Citric Acid and/or Lactic Acid, or Ascorbic Acid | g | 8 |

| | |
|---|---|
| Total: | 1000 |

The test could show the following:

a) the taste was not sufficiently sweet and felt without a bitterness but with much less an unfavorable aftertaste than in Experiment 6;
b) at the same time, the sour taste was not felt;
c) all samples of tea have been sweeten equally;
d) the taste of dry blended compound was better in the case of use Citric Acid and/or Lactic Acid.

The proportions of components were then changed.

### Experiment 8:

Same procedures and steps as for Experiment 1, except changing the amount of components.

| | | |
|---|---|---|
| Erythritol | g | 557 |
| Inulin of Chicory Root | g | 190 |
| Gum Arabic | g | 190 |
| Rebaudioside A, 97% (powder) | g | 55 |
| Citric Acid and/or Lactic Acid, or Ascorbic Acid | g | 8 |

| | |
|---|---|
| Total: | 1000 |

The test could show the following:

a) the taste was sufficiently sweet and felt without a bitterness and without any an unfavorable aftertaste than in the previous Experiments;
b) at the same time, the sour taste was not felt;
c) all samples of tea have been sweeten equally;
d) the taste of dry blended compound was better in the case of use Citric Acid and/or Lactic Acid; at the same time, in the case of use Ascorbic Acid the taste was better than in the previous Experiments.

The proportions of components were then left un changed.

### The Technical and Technological Conditions:

1. The particle sizes of the ingredients should be equal or approximately same. This condition should preferably be kept because of more uniform the particle sizes of the ingredients distribution.
2. The Blender had no mixing devices inside (i.e. paddles, blades); it should be constructed on the principle of “Drum Tumbler”. At the same time, the Blender could have some paddles or stirring tools but only combined with the Grinder, including the Fluidized Paddle Blender.

### The Technological Steps and Instructions:

1. Start to add first into the Blender the smallest amount of the ingredients. This condition must be kept because of more effective and equable of the mixing of the ingredients.
2. Mix all added ingredients about 5-10 minutes but no less than 5 minutes and no more than 10 minutes. This condition must be kept to prevent an insufficient or over mixing. The mixing time is depending on the kind of the blending system.

As a result of these experiments it has been determined that there are three main formulae based on the above formulation, namely:

### Version #1

| Ingredients, % | Min | Max |
|---|---|---|
| Erythritol | 35.0 | 70.0 |
| Inulin from Chicory Root | 10.0 | 25.0 |
| Gum Arabic | 10.0 | 25.0 |
| Stevia Rebaudiana Leaf Extract Rebaudioside A ≧95% | 2.5 | 8.5 |
| Citric Acid | 0.3 | 1.5 |

### Version #2

| Ingredients, % | Min | Max |
|---|---|---|
| Erythritol | 35.0 | 70.0 |
| Inulin from Chicory Root | 10.0 | 25.0 |
| Gum Arabic | 10.0 | 25.0 |
| Stevia Rebaudiana Leaf Extract Rebaudioside A ≧95% | 2.5 | 8.5 |
| Lactic Acid | 0.3 | 1.5 |

### Version #3

| Ingredients, % | Min | Max |
|---|---|---|
| Erythritol | 35.00 | 70.00 |
| Inulin from Chicory Root | 10.00 | 25.00 |
| Gum Arabic | 10.00 | 25.00 |
| Stevia Rebaudiana Leaf Extract Rebaudioside A ≧95% | 2.50 | 8.50 |
| Lactic Acid | 0.15 | 0.75 |
| Citric Acid | 0.15 | 0.75 |

A particularly preferred formulation, suitable for most consumer tastes is as follows.

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Citric Acid, or lactic acid or ascorbic acid | 0.8 |
| Total: | 100.0 |

Examples of Recipes using the sweet-flavouring product are shown below:

### Example 1

### Tea Drink

| Name of Ingredients | % |
|---|---|
| Hot Water | 98.38 |
| Tea (for example: black, green, or herb mixtures,.) | 0.98 |
| sweet-flavouring product | 0.64 |
| Total: | 100.00 |

### Example 2

### Coffee Drink

| Name of Ingredients | % |
|---|---|
| Hot Water | 92.88 |
| Coffee (powder) | 6.19 |
| sweet-flavouring product | 0.93 |
| Total: | 100.00 |

### Example 3

### Herbal Tea

| Name of Ingredients | % |
|---|---|
| Green Tea Leaves | 35.0 |
| Blackcurrant Leaves | 25.5 |
| Elder | 16.5 |
| Fruit Fennel | 8.0 |
| Rose Hip | 8.0 |
| sweet-flavouring product | 6.5 |
| Blackcurrant flavor | 0.5 |
| Total: | 100.00 |

### Example 4

### Fruit Filling

| Name of Ingredients | % |
|---|---|
| Cherry (flesh) | 65.00 |
| Water | 24.47 |
| Kelp Extract | 5.00 |
| sweet-flavouring product | 2.50 |
| Carrageenan | 1.80 |
| Pectin | 0.50 |
| Cherry flavor | 0.30 |
| Locust Bean Gum | 0.30 |
| Xanthan Gum | 0.10 |
| Citric Acid | 0.03 |
| Total: | 100.00 |

### Example 5

### Sweet Bun Recipe

| Name of Ingredients | % |
|---|---|
| All Purpose Flour | 64.10 |
| Water | 25.64 |
| Margarine | 7.70 |
| Yeast (pressed) | 1.60 |
| Salt | 0.64 |
| sweet-flavouring product | 0.32 |
| Total: | 100.00 |

### Quality and Safety Characteristics

| | | |
|---|---|---|
| Parameter Name | Unit | Standard Tolerance |

Physical-chemical Parameters

| | | |
|---|---|---|
| Moisture | % | maximum 5.0% |
| Solubility | | 100% cold water soluble |
| Mesh | | minimum 90% through US |
| | | No. 20 screen |
| Precipitation (residue) | | none detected |
| Appearance | | homogeneous, non-crystalline |
| Color | | blanched almond to white |
| Flavor | | Absent |
| Taste | | sweet, delectable, no after- |
| | | taste, no bitterness |
| Ph | | maximum 4.20 |
| Sweetness | | approx. 35-45 times sweeter |
| | | than sugar |
| Total Soluble Food Fibers | % | 37.50-38.50 |
| Fructo-oligosaccharides (FOS) | % | 18.50-19.50 |
| Erythritol | % | 53.00-57.00 |
| Rebaudioside A (≧97% purity) | % | 5.30-5.90 |

Microbiological Parameters

| | | |
|---|---|---|
| QMAFAnM (TPC) | CFU/g | not >5.0 × 10⁴ |
| Yeast | CFU/g | not >100 |
| Mold | CFU/g | not >100 |
| Total Coliforms | | negative in 0.1 g |
| E. Coli | | negative in 1.0 g |
| Pathogenics, including | | negative in 25.0 g |
| Salmonella | | |
| Listeria monocytogenes | | negative in 25.0 g |

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A food flavouring product for adding a sweet flavour to foods and which contains a combination of erythritol, inulin of chicory root, gum arabic, an extract of stevia, and a compound selected from the group, comprising: ascorbic acid, lactic acid, and citric acid in the following range of predetermined proportions, namely;
Erythritol from 35.0% to 70.0%
Inulin from Chicory Root from 10.0% to 25.0%
Gum Arabic from 10.0% to 25.0%
Stevia Rebaudiana Leaf Extract Rebaudioside A≧95% from 2.5% to 8.5%
Compound selected from ascorbic and Citric and Lactic Acid from 0.3% to 1.5%

2. A food flavouring product as claimed in claim 1 wherein the stevia extract is in the form of rebaudioside-A, (stevia glycosides).

3. A food flavouring product as claimed in claim 2 wherein the compounds are in the following portions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| A compound selected from the group comprising Citric Acid, or | 0.8 |
| lactic acid or ascorbic acid | |
| Total: | 100.0 |

4. A food flavouring product as claimed in claim 3 wherein the components are in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Citric Acid, | 0.8 |
| Total: | 100.0 |

5. A food flavouring product as claimed in claim 3 wherein the components are present in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Lactic Acid | 0.8 |
| Total: | 100.0 |

6. A food flavouring product as claimed in claim 3 wherein the components are in the following proportions namely;

| Ingredients | % |
|---|---|
| Erythritol | 55.7 |
| Inulin from Chicory Root | 19.0 |
| Gum Arabic | 19.0 |
| Stevia Rebaudiana Leaf Extract Rebaudioside A 97% | 5.5 |
| Citric Acid, | 0.4 |
| Lactic acid | 0.4 |
| Total: | 100.0 |
